(19) United States
(12) Patent Application Publication
(10) Pub. No.: US 2006/0222278 A1
(43) Pub. Date: Oct. 5, 2006

(54) Bearing assembly and method of monitoring same

(75) Inventors: Anant Pal Singh, Cincinnati, OH (US); Terry Eugene Viel, Hamilton, OH (US); Malcolm John Ashby, Hamilton, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/093,641

(22) Filed: Mar. 30, 2005

(51) Int. Cl. F16C 41/04; F16C 32/00; F16C 32/06

(52) U.S. Cl. 384/448

(57) ABSTRACT

A method for predicting bearing failure of a differential bearing including an inner race, an outer race, and a plurality of rolling elements positioned between the inner and outer race. The method includes coupling an accelerometer to the differential bearing, generating a bearing performance model, receiving a signal from the accelerometer, and comparing the accelerometer signal to the bearing performance model to predict a differential bearing failure.

### STATEMENT REGARDING FEDERALLY SPONSORED RESEARCH OR DEVELOPMENT

The U.S. Government may have certain rights in this invention pursuant to contract number NAS3-01135 Task Order 23.

### BACKGROUND OF THE INVENTION

This application relates generally to gas turbine engines, and more particularly, to a bearing assembly used within a gas turbine engine and a method of monitoring same.

Gas turbine engines typically include a fan assembly, a core engine including a compressor, a combustor, and a first turbine, i.e. high-pressure turbine, and a second or low-pressure turbine that is coupled axially aft of the core gas turbine engine. The fan assembly and the low pressure turbine are coupled together using a first shaft, and the compressor and the high-pressure turbine are coupled together using a second shaft. At least one known gas turbine engine also include a differential bearing, i.e. inter-shaft bearing, that is coupled between the first and second shafts, respectively.

During operation, failure of a bearing assembly may result in an In Flight Shut Down (IFSD), and/or an Unscheduled Engine Removal (UER). Therefore, at least one known gas turbine engine includes a magnetic chip detection system that includes a magnet that attracts metallic debris that is created during bearing contact fatigue failures such as, but not limited to micro-spalling, peeling, skidding, indentations, and/or smearing. More specifically, magnetic chip detectors facilitate identifying the presence and quantity of metallic debris in a gas turbine lube oil scavenge line. In addition, a scanning electron microscope (SEM) may be used to determine the source of the metallic debris. However, known magnetic chip detection systems and SEM analysis systems can only detect a bearing spalling that has already occurred.

At least one known gas turbine engine also includes a vibration measurement system that transmits relatively high frequency acoustic emissions through the bearing to verify a bearing failure caused by bearing contact fatigue that has previously occurred. However, known vibration measurement systems may not be able to successfully identify the bearing failure if the transmitted signal is degraded when passed through a lubricant film that is used to lubricate the bearing. Therefore, identifying the bearing component frequencies among a plurality of engine operating frequencies may be relatively difficult. Accordingly, known systems are generally not effective in detecting initial bearing flaws and/or defects that may result in bearing spalling, in monitoring bearing damage and/or spall propagation, or in assessing the overall bearing damage including multi-spall initiations and progression.

### BRIEF DESCRIPTION OF THE INVENTION

In one aspect, a method for predicting bearing failure of a differential bearing including an inner race, an outer race, and a plurality of rolling elements positioned between the inner and outer race, is provided. The method includes coupling an accelerometer to the differential bearing, generating a bearing performance model, receiving a signal from the accelerometer, and comparing the accelerometer signal to the bearing performance model to predict a differential bearing failure.

In another aspect, a differential bearing assembly for a rotor is provided. The differential bearing assembly includes an inner race coupled to a first shaft, an outer race coupled to a second shaft, a plurality of rolling elements positioned between the inner and outer races, and an accelerometer coupled to the outer race, the accelerometer configured to transmit a signal to a bearing monitoring system to facilitate predicting a differential bearing failure.

In a further aspect, a gas turbine engine assembly is provided. The gas turbine engine assembly includes a core gas turbine engine that includes a first rotor shaft, a second rotor shaft, a differential bearing coupled between the first and second rotor shafts, and an accelerometer coupled to the differential bearing and configured to transmit a signal to facilitate predicting a failure of the differential bearing failure.

### BRIEF DESCRIPTION OF THE DRAWINGS

FIG. 1 is schematic illustration of an exemplary gas turbine engine assembly;

FIG. 2 is a cross-sectional view of an exemplary differential bearing assembly that may be used in the gas turbine engine shown in FIG. 1;

FIG. 3 is a cross-sectional view of an exemplary outer race that may be used with the differential bearing assembly shown in FIG. 2;

FIG. 4 is a perspective view of the outer race shown in FIG. 2;

FIG. 5 is a bearing monitoring system that may be used to monitor the differential bearing assemblies shown in FIGS. 2 and 3; and

FIGS. 6 and 7 are graphical illustrations of data generated by the bearing monitoring system during normal operation.

### DETAILED DESCRIPTION OF THE INVENTION

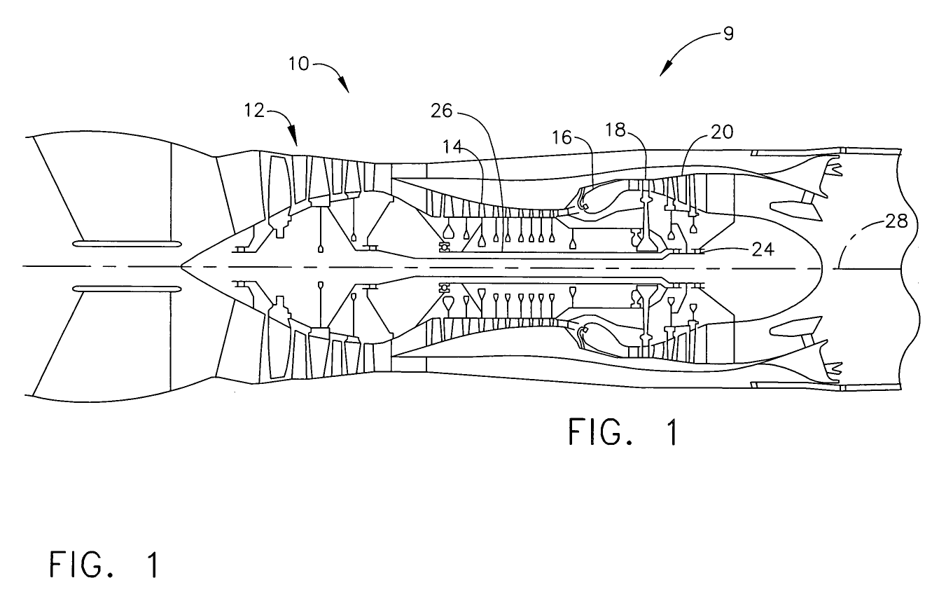

FIG. 1 is a schematic illustration of an exemplary gas turbine assembly 9 that includes a core gas turbine engine 10 including a fan assembly 12, a high pressure compressor 14, and a combustor 16. In the exemplary embodiment, gas turbine engine 10 is a military gas turbine engine that is available from General Electric Company, Cincinnati, Ohio. Gas turbine engine 10 also includes a high pressure turbine 18 and a low pressure turbine 20. Fan assembly 12 and turbine 20 are coupled by a first shaft 24, and compressor 14 and turbine 18 are coupled by a second shaft 26. First shaft 24 is coaxially positioned within second shaft 26 about a longitudinal centerline axis 28 of engine 10.

In operation, air flows through fan assembly 12 and compressed air is supplied from fan assembly 12 to high pressure compressor 14. The highly compressed air is delivered to combustor 16. Airflow from combustor 16 drives rotating turbines 18 and 20 and exits gas turbine engine 10 through an exhaust system (not shown).

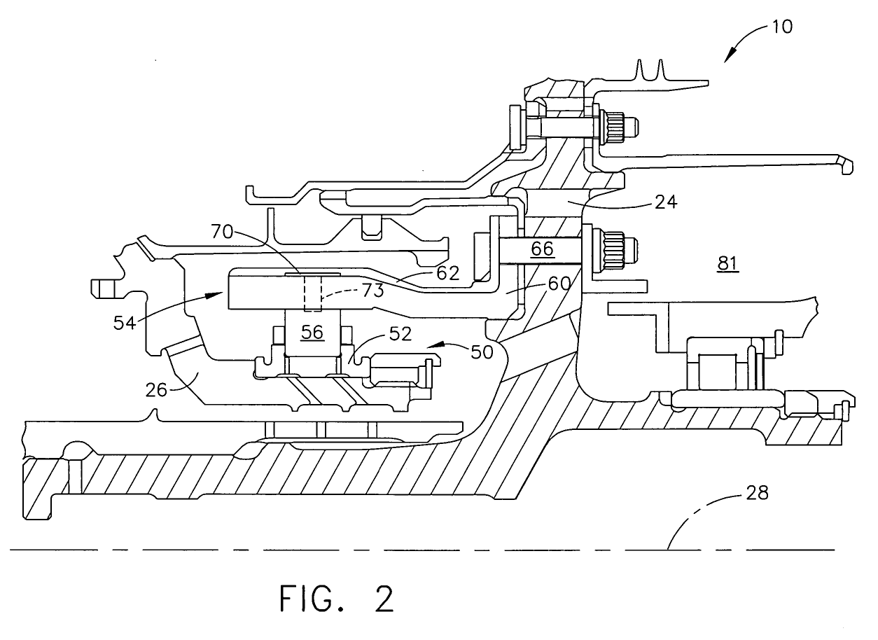

FIG. 2 is a cross-sectional view of an exemplary embodiment of a differential bearing assembly 50 that may be used with a gas turbine engine, such as engine 10 shown in FIG. 1. In the exemplary embodiment, differential bearing assembly 50 is coupled between first shaft 24 and second shaft 26. Although, the invention described herein is with respect to a single differential bearing 50, it should be realized that the invention described herein may also be utilized with a gas turbine engine that includes a plurality of differential bearings 50. Moreover, the invention described herein may also be utilized with a plurality of roller and/or ball bearing assemblies within gas turbine engine 10.

Differential bearing assembly 50 includes a rotating inner race 52 secured to shaft 26 that extends between high pressure turbine 18 and high pressure compressor 14. Differential bearing assembly 50 also includes a rotating outer race 54 that is secured to shaft 24 that extends between low pressure turbine 20 and fan assembly 12, and a plurality of bearings 56, i.e. rolling elements, that are positioned between inner and outer races 52 and 54 respectively. In the exemplary embodiment, bearings 56 are roller bearings. In an alternative embodiment, bearings 56 are ball bearings.

In the exemplary embodiment, (shown in FIG. 2) outer race 54 includes a first portion 60 that is substantially L-shaped, a second portion 62 that is substantially L-shaped, and at least one measuring device 70 that is coupled to first portion 60. In the exemplary embodiment, measuring device 70 is positioned between first and second portions 60 and 62. More specifically, measuring device 70 is coupled to first portion 60, and second portion 62 is coupled circumferentially around an exterior surface of both measuring device 70 and first portion 60 to facilitate protecting measuring device 70 from damage. In the exemplary embodiment, both first and second portions 60 and 62 are coupled to shaft 24 using a plurality of fasteners 66, and are therefore configured to rotate with shaft 24.

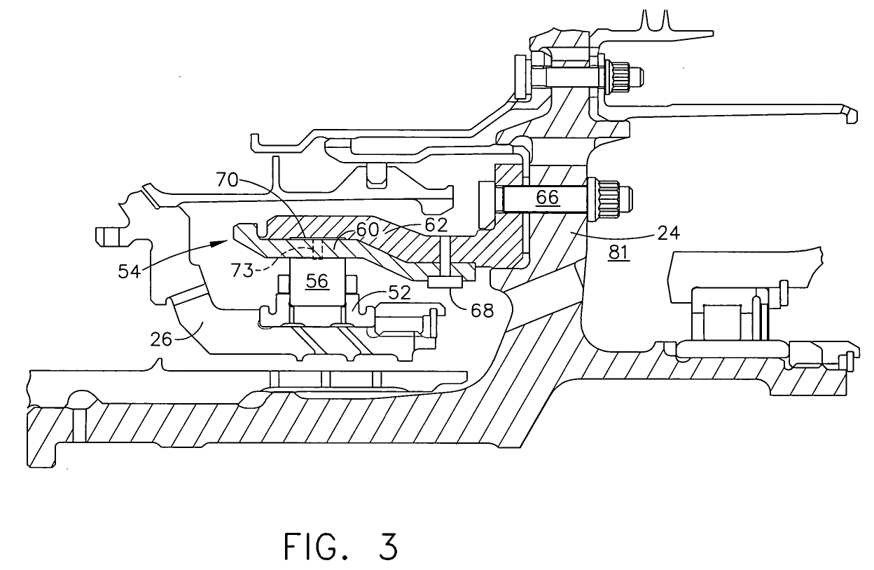

In another exemplary embodiment (shown in FIG. 3), outer race 54 includes first portion 60 and second portion 62 that is substantially L-shaped, and at least one measuring device 70 that is coupled to first portion 60. In the exemplary embodiment, measuring device 70 is positioned between first and second portions 60 and 62. More specifically, measuring device 70 is coupled to first portion 60 and second portion 62 is coupled radially around an exterior surface of both measuring device 70 and first portion 60 to facilitate protecting measuring device 70 from damage. In the exemplary embodiment, first portion 60 is coupled to second portion 62 using a plurality of fasteners 68, and second portion 62 is coupled to shaft 24 using a plurality of fasteners 66. Accordingly, and in the exemplary embodiment, first and second portions 60 and 62, and measuring device 70 are all configured to rotate with shaft 24.

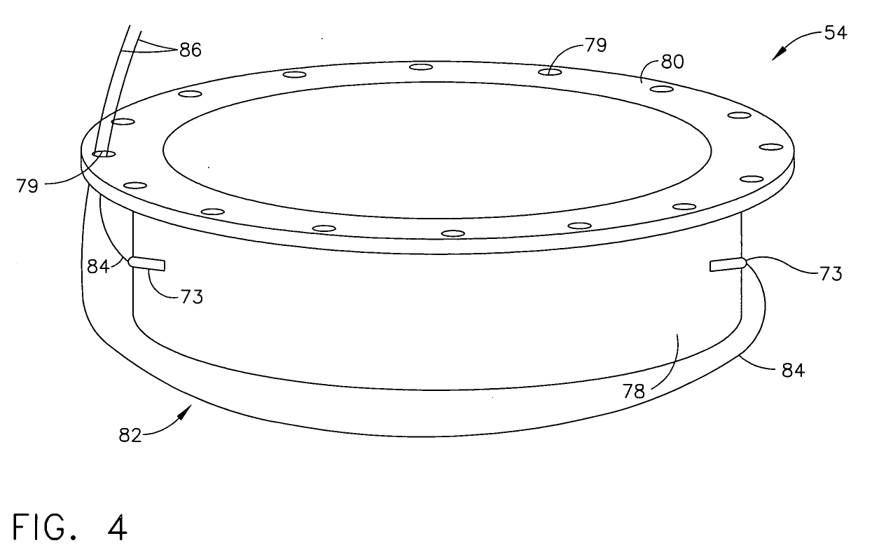

FIG. 4 is a perspective view of outer race 54 (shown in FIGS. 2 and 3) that includes measuring device 70. Measuring device 70 is coupled to outer race 54 and is therefore configured to rotate with outer race 54. In the exemplary embodiment, measuring device 70 is an accelerometer 73 that is configured to transmit a signal indicative of acceleration and/or velocity of outer race 54. More specifically, accelerometer 73 monitors changes in acceleration, i.e. the rate of change of velocity with respect to time, of outer race 54, and communicates these changes to a bearing monitoring system.

Accelerometer 73 is suitably configured to measure acceleration and may include at least one of a piezo-film accelerometer, surface micro-machined capacitive (MEMS) accelerometer, a bulk micro-machined capacitive accelerometer, a piezo-electric accelerometer, a magnetic induction accelerometer, and/or an optical accelerometer, for example.

In the exemplary embodiment, accelerometer 73 is coupled to outer race exterior surface 78 and extends at least partially through outer race 54 such that accelerometer 73 rotates with outer race 54. In one embodiment, bearing assembly 50 includes at least one accelerometer 73. In the exemplary embodiment, bearing assembly 50 includes two accelerometers 73. In an alternative embodiment, bearing assembly 50 includes more than two accelerometers 73 that are each coupled to outer race 54 and therefore configured to rotate with outer race 54.

Outer race 54 also includes a mounting flange 80 that is configured to couple outer race 54 to gas turbine engine 10. Specifically, mounting flange 80 includes a plurality of openings 79 that are sized to receive a fastener 66 to facilitate coupling outer race 54 to shaft 24. In the exemplary embodiment, outer race 54 and flange 80 are formed together unitarily.

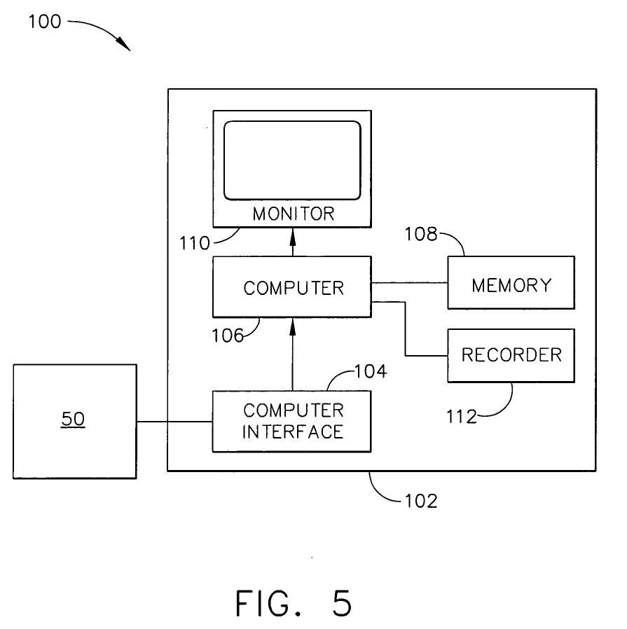

Bearing assembly 50 also includes a wiring harness 82 to facilitate electrically coupling accelerometers 73 to a bearing monitoring system such as bearing monitoring system 100 (shown in FIG. 5). Wiring harness 82 is coupled to a transmitter (not shown) that is configured to transmit a signal such as, but not limited to, an RF signal, to bearing monitoring system 100. In an alternative embodiment, wiring harness 82 is electrically coupled to bearing monitoring system 100 using a plurality of electrical connectors (not shown). During assembly, a wiring harness first end 84 is coupled to each respective accelerometer 73, and a wiring harness second end 86 is channeled through at least one opening 79 and into a bearing cavity 81 to facilitate transmitting a signal such as, but not limited to, an RF signal, to bearing monitoring system 100.

FIG. 5 is a bearing monitoring system 100 that may be used to monitor a gas turbine engine bearing such as, but not limited to, bearing assembly 50 (shown in FIG. 2). In the exemplary embodiment, bearing monitoring system 100 is coupled to core gas turbine engine 10 and includes a data acquisition/control system 102 that is coupled to bearing assembly 50 such that data collected from bearing assembly 50 can be transmitted to/from data acquisition/control system 102. Data acquisition/control system 102 includes a computer interface 104, a computer 106, such as a personal computer, a memory 108, and a monitor 110. Computer 106 executes instructions stored in firmware (not shown). Computer 106 is programmed to perform functions described herein, and as used herein, the term computer is not limited to just those integrated circuits referred to in the art as computers, but broadly refers to computers, processors, micro controllers, microcomputers, programmable logic controllers, application specific integrated circuits, and other programmable circuits, and these terms are used interchangeably herein.

Memory 108 is intended to represent one or more volatile and/or nonvolatile storage facilities not shown separately that are familiar to those skilled in the art. Examples of such storage facilities often used with computer 106 include solid state memory (e.g., random access memory (RAM), read-only memory (ROM), and flash memory), magnetic storage devices (e.g., floppy disks and hard disks), optical storage devices (e.g., CD-ROM, CD-RW, and DVD), and so forth. Memory 108 may be internal to or external to computer 106. In the exemplary embodiment, data acquisition/control system 102 also includes a recording device 112 such as, but not limited to, a strip chart recorder, a C-scan, and an electronic recorder, electrically coupled to at least one of computer 106 and bearing assembly 50.

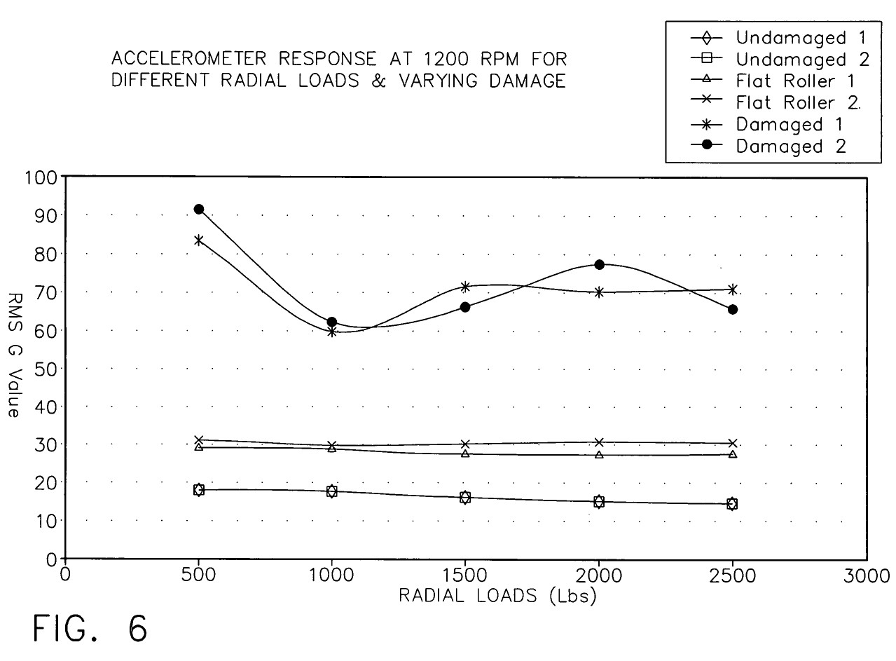

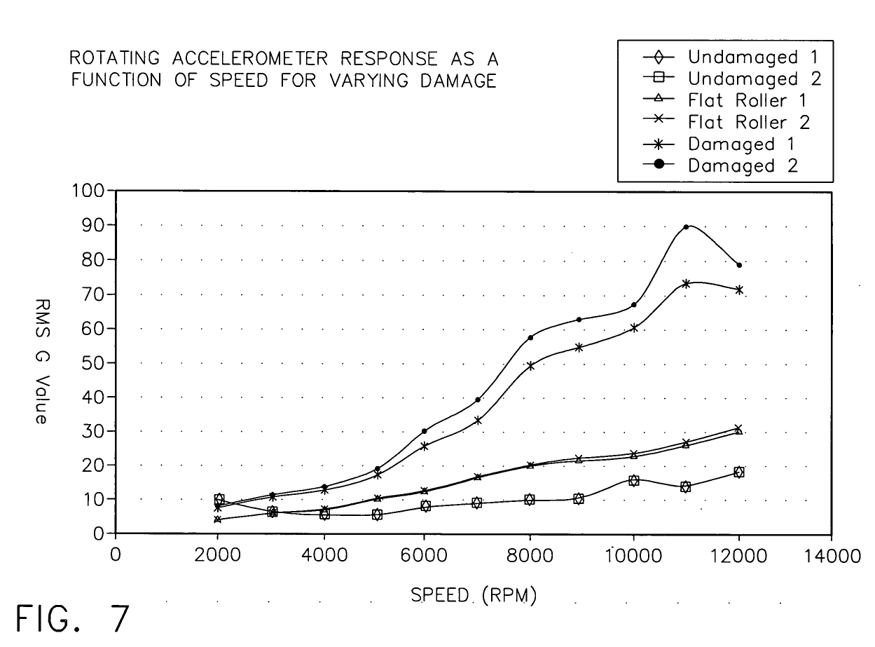

FIGS. 6 and 7 are graphical illustrations that may be generated by bearing monitoring system 100 during normal operation. During engine operation, a signal indicative of bearing outer race acceleration is transmitted from accelerometers 73 to bearing monitoring system 100. In the exemplary embodiment, data collected from each respective accelerometer 73 is compared to known bearing data using an algorithm, installed on computer 106 for example, to determine a resultant acceleration for differential bearing assembly 50. More specifically, computer 106 utilizes the information received from accelerometers 73 to determine an amplitude and frequency of a signal received from accelerometers 73. Accordingly, the acceleration of outer race 54 can be utilized as an indicator of bearing wear for any bearing such as, but not limited to, differential bearing assembly 50.

For example, as shown in FIG. 6, data received from accelerometers 73 is graphed utilizing bearing monitoring system 100. As shown in FIG. 6, a portion of the graphical illustration shows bearing assembly 50 is operating normally, i.e. bearing assembly 50 does not indicate any potential failure, whereas another portion of FIG. 6 indicates that bearing assembly 50 may have at least one of a flat roller and/or a damaged portion. More specifically, data collected from bearing assembly 50, under varying radial loads (Lbs), is represented as a frequency response curve that includes a bearing amplitude (in RMS G) and the corresponding radial load on bearing assembly 50. As illustrated in FIG. 6, the RMS G value data collected from each accelerometer 73 varies from a known RMS G value when bearing assembly 50 is experiencing bearing damage and/or spall propagation which may result in an In Flight Shut Down (IFSD), and/or an Unscheduled Engine Removal (UER).

Moreover, as shown in FIG. 7, a portion of the graphical illustration shows bearing assembly 50 is operating normally, i.e. bearing assembly 50 does not indicate any potential failure, whereas another portion of FIG. 7 inidicates that bearing assembly 50 may have at least one of a flat roller and/or a damaged portion. More specifically, data collected from bearing assembly 50, under varying bearing rotational speeds (RPM), is represented as a frequency response curve that includes a bearing amplitude (in RMS G) and the corresponding bearing speeds (RPM) of bearing assembly 50. As illustrated in FIG. 7, the RMS G value data collected from each accelerometer 73 varies from a known RMS G value when bearing assembly 50 is experiencing bearing damage and/or spall propagation which may result in an In Flight Shut Down (IFSD), and/or an Unscheduled Engine Removal (UER).

Accordingly, accelerometers 73 and bearing monitoring system 100 facilitate predicting a bearing failure. More specifically, data is continuously collected from bearing assembly 50 utilizing bearing monitoring system 100. The data is then analyzed utilizing the algorithm installed on computer 106 to evaluate the current operational state of bearing assembly 50. In the exemplary embodiment, the data is compared to known data, i.e. a bearing performance model, to estimate a future date in which bearing assembly 50 may possibly fail. Accordingly, bearing assembly 50 can be repaired or replaced prior to an In Flight Shut Down (IFSD) to facilitate avoiding an Unscheduled Engine Removal (UER).

The bearing assembly described herein can therefore be utilized to predict damage to a differential bearing before significant damage occurs. Specifically, the accelerometers that are coupled to the bearing assembly facilitate determining current damage to the differential bearing and then predicting damage progression to the bearing such as pitting, peeling, indentation, or smearing. The accelerometers described herein are also effective in determining when the lubricant film between the ball and the damaged raceway are creating a metal-to-metal contact since the signature of the bearing is different than the baseline signature.

The above-described bearing assemblies are cost-effective and highly reliable. The bearing assembly includes an inner race, an outer race, and at least one accelerometer that is coupled to the outer race. The accelerometer facilitates detecting initial bearing flaws and/or defects that may result in bearing spalling, monitoring bearing damage and/or spall propagation, and/or assessing the overall bearing damage including multi-spall initiations and progression. As a result, the bearing assembly, including the accelerometer, facilitates reducing In Flight Shut Downs and/or Unscheduled Engine Removals.

Exemplary embodiments of a bearing assembly are described above in detail. The bearing assembly is not limited to the specific embodiments described herein, but rather, components of each bearing assembly may be utilized independently and separately from other components described herein. Specifically, the accelerometer described herein can also be used in combination with a wide variety of bearings in a variety of mechanical systems.

While the invention has been described in terms of various specific embodiments, those skilled in the art will recognize that the invention can be practiced with modification within the spirit and scope of the claims.

What is claimed is:

1. A method for predicting bearing failure of a differential bearing including an inner race, an outer race, and a plurality of rolling elements positioned between the inner and outer race, said method comprising:
coupling at least one accelerometer to the differential bearing;
generating a bearing performance model;
receiving a signal from the at least one accelerometer; and
comparing the accelerometer signal to the bearing performance model to predict a differential bearing failure.

2. A method in accordance with claim 1 wherein coupling at least one accelerometer to the differential bearing comprises coupling at least one accelerometer to the differential bearing outer race such that the accelerometer rotates with the outer race.

3. A method in accordance with claim 2 wherein said outer race comprises a first portion and a second portion, said method further comprising coupling an accelerometer to the first portion, and coupling the second portion circumferentially around the first portion to facilitate protecting the accelerometer.

4. A method in accordance with claim 1 further comprising coupling the differential bearing between a first shaft and a second shaft.

5. A method in accordance with claim 1 further comprising transmitting a signal from the accelerometer to a bearing monitoring system utilizing a radio frequency signal.

6. A method in accordance with claim 1 further comprising:
utilizing the accelerometer signal to identify a bearing spall; and
utilizing a bearing monitoring system to monitor the progression of the bearing spall.

7. A differential bearing assembly for a rotor, said differential bearing assembly comprising:
an inner race coupled to a first shaft;
an outer race coupled to a second shaft;
a plurality of rolling elements positioned between said inner and outer races; and
at least one accelerometer coupled to said outer race, said at least one accelerometer configured to transmit a signal to a bearing monitoring system to facilitate predicting a failure of said differential bearing.

8. A differential bearing assembly in accordance with claim 7 wherein said outer race comprises:
a first portion; and
a second portion coupled circumferentially around said first portion to facilitate protecting said accelerometer.

9. A differential bearing assembly in accordance with claim 7 wherein said at least one accelerometer comprises at least one of a capacitance accelerometer and a inductive accelerometer.

10. A differential bearing assembly in accordance with claim 7 wherein said at least one accelerometer is configured to transmit a signal to said bearing monitoring system utilizing a radio frequency signal.

11. A differential bearing assembly in accordance with claim 7 wherein said outer race comprises a plurality of openings, said bearing assembly further comprises:
a plurality of fasteners extending through said openings and configured to couple said outer race to said second shaft; and
a wiring harness coupled to said at least one accelerometer, said wiring harness inserted through at least one of said plurality of openings.

12. A differential bearing assembly in accordance with claim 7 wherein said bearing monitoring system is configured to utilize the accelerometer signal to identify a bearing spall and monitor the progression of the bearing spall.

13. A differential bearing assembly in accordance with claim 7 wherein said differential bearing assembly further comprises exactly two accelerometers that are coupled to said outer race.

14. A gas turbine engine assembly comprising:
a core gas turbine engine comprising
a first rotor shaft;
a second rotor shaft;
a differential bearing coupled between said first and second rotor shafts; and
at least one accelerometer coupled to said differential bearing and configured to transmit a signal to facilitate predicting a failure of said differential bearing.

15. A gas turbine engine assembly in accordance with claim 14 wherein said differential bearing comprises:
an inner race coupled to said first shaft;
an outer race coupled to said second shaft; and
a plurality of rolling elements positioned between said inner and outer races, said at least one accelerometer coupled to said outer race.

16. A gas turbine engine assembly in accordance with claim 15 wherein said outer race comprises:
a first portion; and
a second portion coupled circumferentially around said first portion to facilitate protecting said at least one accelerometer.

17. A gas turbine engine assembly in accordance with claim 14 wherein said differential bearing comprises exactly two accelerometers coupled to said differential bearing.

18. A gas turbine engine assembly in accordance with claim 15 wherein said outer race comprises a plurality of openings, said differential bearing assembly further comprises:
a plurality of fasteners extending through said openings and configured to couple said outer race to said second shaft; and
a wiring harness coupled to said accelerometer, said wiring harness inserted through at least one of said plurality of openings.

19. A gas turbine engine assembly in accordance with claim 14 further comprising a bearing monitoring system, said at least one accelerometer is configured to transmit a signal to said bearing monitoring system utilizing a radio frequency signal.

20. A gas turbine engine assembly in accordance with claim 19 wherein said bearing monitoring system is configured to utilize the accelerometer signal to identify a bearing spall and monitor the progression of the bearing spall.
